(19) United States
(12) Patent Application Publication
(10) Pub. No.: US 2018/0000252 A1
(43) Pub. Date: Jan. 4, 2018

(54) Convertible Chair, Cart and Transport Device

(71) Applicants: Julie Weldon, Mt. Pleasant, SC (US); James Kindley, Johns Island, SC (US)

(72) Inventors: Julie Weldon, Mt. Pleasant, SC (US); James Kindley, Johns Island, SC (US)

(21) Appl. No.: 15/619,080

(22) Filed: Jun. 9, 2017

Related U.S. Application Data
(60) Provisional application No. 62/348,568, filed on Jun. 10, 2016.

(51) Int. Cl. A47C 13/00; B62B 1/12

(52) U.S. Cl. CPC A47C 13/00; B62B 1/12

(57) ABSTRACT

A wheeled device that converts between a chair, a vertical dolly and a flat 2-wheeled wagon. A rigid frame includes parts coupled by rotating hinges. Two handles swivel with respect to one another to act both as handles and as rear chair legs. In the dolly mode, the tip of the frame and its slats rotate 90 degrees to form the bottom of the dolly. The present invention, in addition to being a basic convertible device, can optionally be equipped with modern features such as a solar-powered USB port charger. The invention also allows for different accoutrements for specialized activities such as hunting, fishing, camping RV'ing, beach, outdoor sports, tailgating and the like. In the chair mode, the present invention can have multiple reclining positions with the ability to lie flat. In addition, the device can be made to place the chair closer to the ground for activities like gardening.

This application is related to, and claims priority from, U.S. Provisional Patent Application No. 62/348,568 filed Jun. 10, 2016. Application 62/348,568 is hereby incorporated by reference in its entirety.

### BACKGROUND

### Field of the Invention

The present invention relates generally to wheeled devices that convert from one mode to another and more particularly to a convertible chair, cart and transport device.

### Description of the Prior Art

Chairs with wheels are known in the art as are push dollies and flat wagon type carts. Weldon in U.S. Patent No. 6,131,925 teaches a beach chair that folds up into a cart designed to carry beach equipment. Weldon et al. in U.S. Pat. No. 8,814,181 teach a base with wheels that accepts a foldable beach chair. While these devices are useful, they do not serve the three-fold purpose of acting as a wheeled chair, a dolly and a flat wagon cart.

It would be advantageous to have a device that overcomes the shortcomings of the prior art foldable devices and provides all three modes.

### SUMMARY OF THE INVENTION

The present invention relates to a wheeled device that readily converts between a beach chair, a standard vertical dolly and a flat 2-wheeled wagon. A rigid frame includes at least two parts coupled by rotating hinges. Two handles swivel with respect to one another to act both as handles and as rear chair legs. In the dolly mode, the tip of the frame and its slats rotate 90 degrees to form the bottom of the dolly. The present invention, in addition to being a basic convertible device, can optionally be equipped with modern features such as a solar-powered USB port charger. The invention also allows for different accoutrements (or models) for specialized activities such as hunting, fishing, camping RV'ing, beach, outdoor sports, tailgating and the like. In the chair mode, the present invention can have multiple reclining positions with the ability to lie flat. In addition, the device can be made to place the chair closer to the ground for activities like gardening.

### DESCRIPTION OF THE FIGURES

Attention is now directed to several figures that illustrate features of embodiments of the present invention:

FIG. 1 shows a perspective view of an embodiment of the present invention in the dolly mode.

FIG. 2 is a side view of the device of FIG. 1.

FIG. 3 shows a top view of the embodiment of FIG. 1 in a chair mode.

FIG. 4 shows the chair mode from the side.

FIG. 5 shows a perspective view of the chair mode.

FIG. 6A shows a back perspective view of the chair mode.

FIG. 6B shows a portion of FIG. 6A with a utility saddle bag.

FIG. 6C shows the utility saddle bag having a solar panel.

FIG. 7 is another back perspective view of the embodiment of FIG. 6A having an utility saddle bag and showing the ability to recline at different angles.

FIG. 8A shows a top view of the device in a flat 2-wheel cart mode.

FIG. 8B shows a slightly elevated perspective view of the cart mode.

FIG. 8C shows a side view of the cart mode.

Several drawings and illustrations have been presented to aid in understanding the present invention. The scope of the present invention is not limited to what is shown in the figures.

### DESCRIPTION OF THE PREFERRED EMBODIMENTS

The present invention relates to a convertible device that can become a vertical dolly, a flat cart and a chair with different reclining angles and different seat heights.

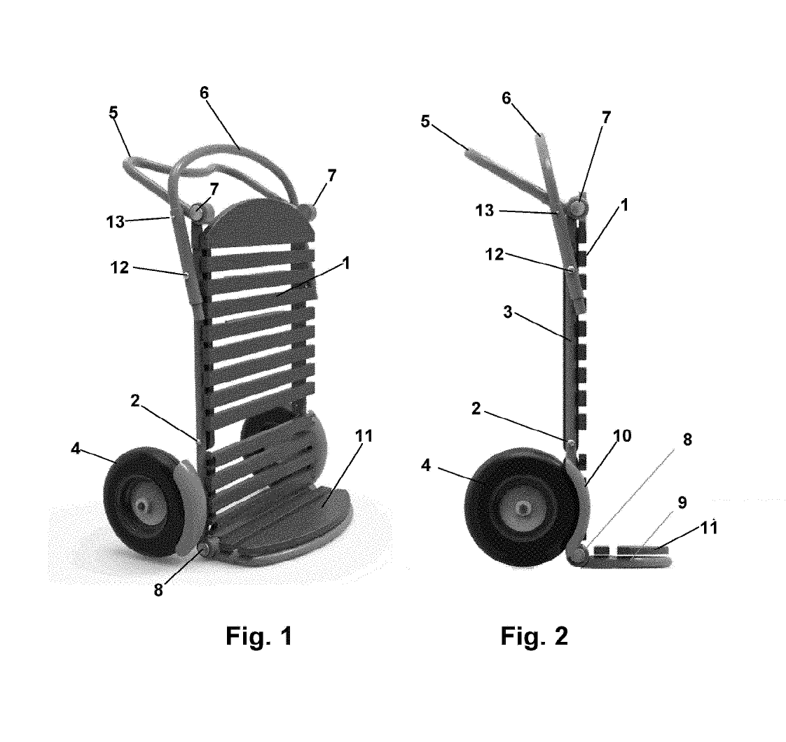

The invention is equipped with at least two wheels 4 attached to one end (a distal end) of an elongated frame as shown in FIGS. 1-2. The frame can preferably be made from aluminum for lightness and strength; however, any rigid material may be used. The wheels 4 can also have fenders 10. The surface of the frame includes a series of wooden, or other rigid material slats 1, 11 separated from one-another by approximately the width of the slat. The lower tip of the frame 9, along with the lower slats 11, are attached to a pivoting frame that can be folded from a flat configuration to a configuration where the lower tip is perpendicular to the rest of the frame 2 as shown in FIG. 1. The fold takes place at a cylindrical hinge 8 located where the tip part of the frame 9 meets the main part of the frame 3. FIGS. 1-2 show what can be called the dolly mode of the device. The preferred width of the wheel base is around 31 inches with the preferred width of the main frame and slats being around 22-23 inches. While these are preferred sizes, any sizes are within the scope of the present invention. In the dolly mode, the bottom of the wheel 4 and the dolly foot are flush with the ground. The slats are preferably made of wood.

Other features shown in FIGS. 1-2 are a first handle 6 that can pivot from the frame 3 on a pin 12. A second handle 5 is attached to the frame 3 with a cylindrical hinge 7. The first handle 6 can lock to the second handle 5 with a pin 13 that runs between the two handles. Pins 12 and 13 can also be cylindrical hinges in various embodiments of the invention. The second handle can be mounted between one and six inches forward of the first handle.

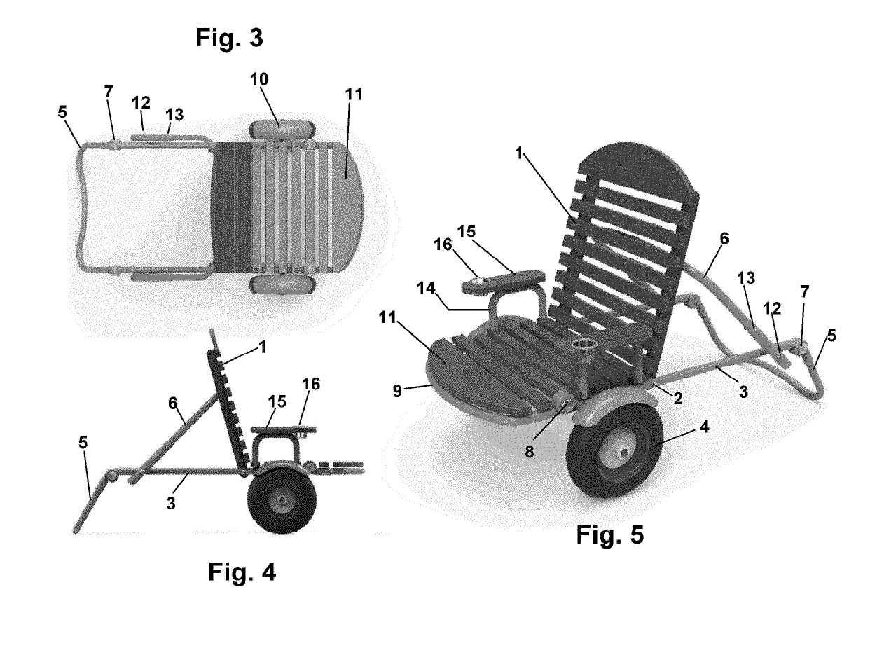

FIGS. 3-5 show the device in what can be called the chair configuration. In this configuration, the tip of the frame 9 is folded along the cylindrical hinge 8 so as to form a flat seat with the main frame 3. The upper part of the frame slats 1 fold upward along the pin 2 to form a back. The back is locked at a selectable recline angle by the second handle 6, which in this configuration is unlocked from the first handle 5. Handle 5 folds downward along the cylindrical hinge 7 to act as a real leg for the chair. The chair can be equipped with optional arms 15 with an optional drink holder 16. An umbrella holder (not shown) can also be added for beach comfort. In the chair configuration, the wheels 4 can optionally lock to prevent unwanted rolling.

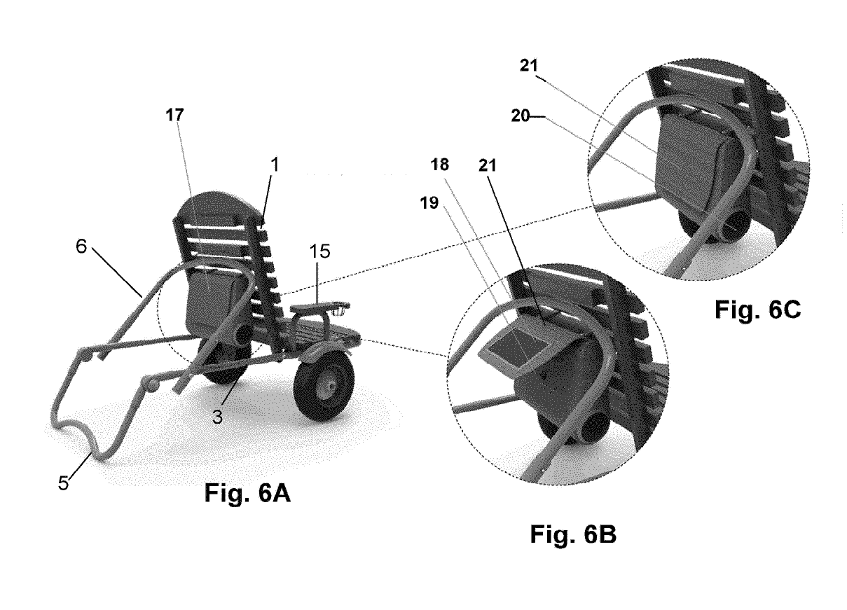

FIG. 6A shows a rear perspective view of the chair mode with an optional utility saddle bag or pouch 17. This can be made from Nylon™ or any other flexible material. FIG. 6B shows the pouch having a flap lid 21 that has an optional solar panel 18 that can supply charge through a USB port. An optional flip-out bar 19 can keep the solar panel oriented skyward. FIG. 6C shows a lid 21 with no solar panel. In addition FIGS. 6B and 6C show optional speakers 19 that can be mounted on the utility bag or elsewhere on the device. Various interfaces can be supplied for connection to smartphones and other music devices.

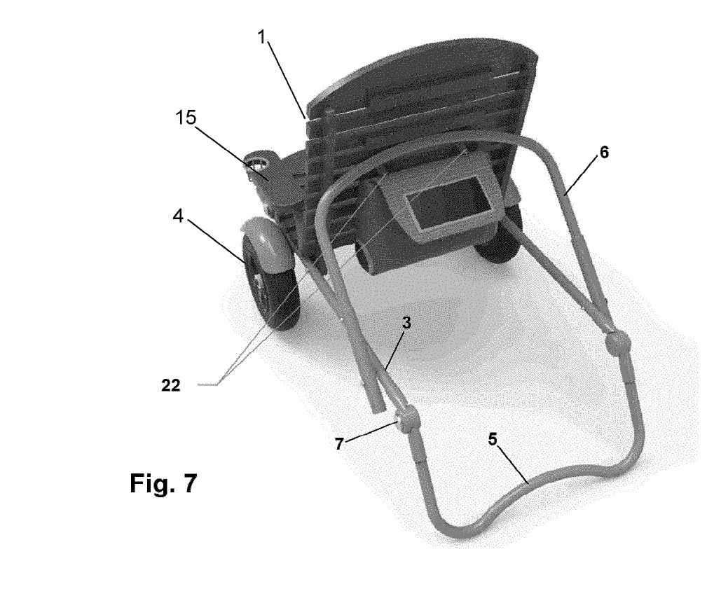

FIG. 7 shows a back view of the chair mode from another angle. The utility bag is attached to the seat back with two clips 22 or other attachment devices. This view clearly shows the relationship between the handle 5, the handle 6, the main frame 3 and the cylindrical hinge 7 in this chair mode.

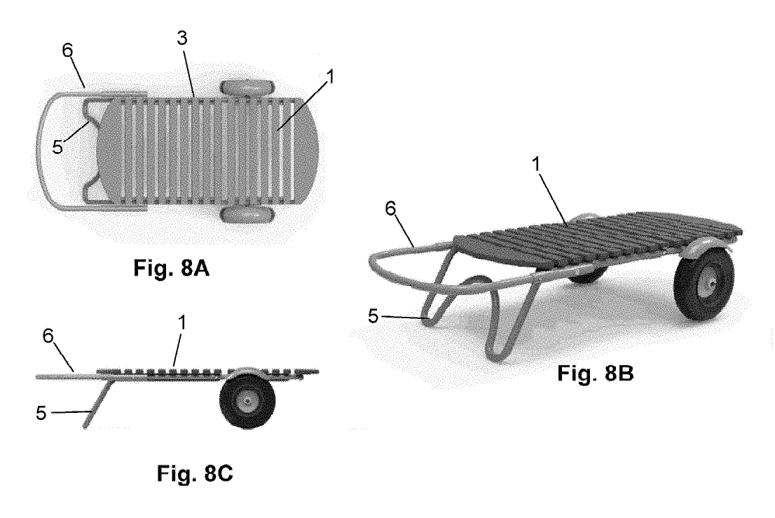

FIGS. 8A, 8B and 8C shows the flat wagon cart mode. Here, the hinges and pins are set so that the entire main frame 3 including handle 6 lies flat. Handle 5 still acts as a rear leg for the device. This mode is simply the extreme of the chair mode with handle 6 removed from the chair slats 1 and the entire chair back reclined to 180 degrees. The pin 12 can be screwed down, or otherwise tightened, to make the entire frame including the main frame 3 and the handle 6 rigid. Handle 6 can the be used to port the cart. The preferred length of the extended frame 3 and handle 6 is around 58-59 inches. While this is a preferred length, any length is within the scope of the present invention.

Numerous accessories may be used with the present invention. They can include, but are not limited to, the solar-powered USB charger previously discussed; fishing rod holders; large bungee straps to hold everything on cart; wagon sides; hooks on back of chair to hang or hold towels/hats/etc.; storage compartment or compartments; shade canopy; umbrella holder; removable seat cushions; and an extension at seat base (leg support) to convert chair to a lounger.

Several descriptions and illustrations have been presented to aid in understanding the present invention. One with skill in the art will realize that numerous changes and variations may be made without departing from the spirit of the invention. Each of these changes and variations is within the scope of the present invention.

We claim:

1. A folding combination wheeled device comprising:
a rigid base frame that includes two equal length, substantially parallel bars, wherein a distance between the bars is smaller then their length;
a first plurality of flat attached slats between the two bars, the slats being substantially perpendicular to the bars and attached to the bars from a distal end of the bars up to a point approximately a third of the length of the two bars, the flat attached slats being separated from one another by a space approximately equal to the width of the flat attached slats;
a second plurality of flat slats also perpendicular to the two bars attached to a folding frame and separated from on another by a space approximately equal to the width of the flat slats, the folding frame pivotably attached to the two bars at a point proximate to where the first plurality of attached slats ends, the folding frame and second plurality of slats extending to a proximal end of the two bars, the folding frame in a first configuration being free to lie parallel to the two bars, or in a second configuration, folding away from the two bars;
first and second swiveling handles both pivotably attached to the two bars at the proximal end;
two wheels also attached to the two bars at their distal end;
a flat base hingedly coupled to the distal end of the two bars, the flat base free to rotate to a first position parallel to the two bars or to a second position perpendicular to the two bars;
the rigid frame, folding frame, base and wheels configured so that the device can exist in three modes:
a dolly mode where the folding frame is in the first configuration, the flat base is in the first position, and the device becomes a dolly;
a chair mode where the folding frame is in the second configuration, the flat base is in the second position, and the device becomes a wheeled chair; and
a flat cart mode where the folding frame is in the first configuration, the flat base is in the second position, and the device becomes a flat 2-wheeled cart.

2. The combination wheeled device of claim 1 wherein the two bars are aluminum tubing and the first and second pluralities of flat slats, and the folding frame, are wooden.

3. The combination wheeled device of claim 1 further comprising a drinking cup holder attachable to one of the two bars in the chair mode.

4. The combination wheeled device of claim 1 further comprising a saddle bag attachable to one of the swivel handles and resting behind the second plurality of flat slats in the chair mode.

5. The combination wheeled device of claim 4 wherein the saddle bag has a sun port adapted to hold solar cells.

6. The combination wheeled device of claim 1 further comprising a fender mounted to one of the two bars above each wheel.

7. The combination wheeled device of claim 1 wherein the first swiveling handle is attached to the two bars at the distal end, and the second swiveling handle is attached to the two bars at a point between one and six inches distal to the first swiveling handle.

8. The combination wheeled device of claim 7 wherein the second swiveling handle pivots upward to an angle of approximately 45 degrees to support the folding frame in the chair mode.

9. The combination wheeled device of claim 8 wherein the first swiveling handle pivots downward to support the two bars in a position in the chair mode and the wagon mode.

10. The combination wheeled device of claim 1 wherein the first swiveling handle is approximately arch-shaped, and the second swiveling handle is bent concave inward at its center.

11. A combination wheeled device comprising a frame, two wheels mounted on a distal end of said frame, a slated pivoting back, two pivoting handles mounted on a proximal end of said frame, and a folding base attached to the distal end of the frame, the device having three configurations:
a dolly configuration wherein the frame and pivoting back are parallel and the base is perpendicular to the frame, the handles protruding from a proximal end of the frame, the device forming a dolly.
a chair configuration wherein the frame and pivoting back are substantially perpendicular, the base is parallel to the folding frame, and wherein one handle supports the folding back in an upright position, and the other handle supports the frame in a horizontal position, the device forming a chair;
a cart configuration wherein the frame, base and pivoting back are all parallel, one of the handles supporting the frame base and back in a horizontal position, the device forming a cart.

12. The combination wheeled device of claim 11 wherein the frame is aluminum tubing and the flat slats and folding back are wooden.

13. The combination wheeled device of claim 11 further comprising a drinking cup holder attachable to said frame in the chair configuration.

14. The combination wheeled device of claim 11 further comprising a saddle bag attachable to one of the pivoting handles and resting behind the folding back in the chair mode.

15. The combination wheeled device of claim 14 wherein the saddle bag has a sun port adapted to hold solar cells.

16. The combination wheeled device of claim 11 wherein a first of the pivoting handles is attached to the frame at its distal end, and the second of the pivoting handles is attached to the frame at a point between one and six inches distal to the first swiveling handle.

17. The combination wheeled device of claim 16 wherein the second swiveling handle pivots upward to an angle of approximately 45 degrees to support the folding frame in the chair configuration.

18. The combination wheeled device of claim 17 wherein the first swiveling handle pivots downward to support frame in a position in the chair mode and the cart configuration.

19. The combination wheeled device of claim 11 wherein the length of the frame and second handle is approximately 58-59 inches in the cart configuration.
